(19) United States
(12) Patent Application Publication
(10) Pub. No.: US 2013/0266063 A1
(43) Pub. Date: Oct. 10, 2013

(54) VIDEO ENCODING METHOD AND APPARATUS FOR FAST INTRA PREDICTION

(71) Applicant: ELECTRONICS AND TELECOMMUNICATIONS RESEARCH, Daejeon (KR)

(72) Inventors: Dong San JUN, Daejeon (KR); Youn Hee KIM, Daejeon (KR); Soon heung JUNG, Daejeon (KR); Jin Soo CHOI, Daejeon (KR); Jin Woong KIM, Daejeon (KR)

(73) Assignee: Electronics and Telecommunications Research Institute, Daejeon (KR)

(21) Appl. No.: 13/658,198

(22) Filed: Oct. 23, 2012

(30) Foreign Application Priority Data
Apr. 4, 2012 (KR) 10-2012-0034691

(51) Int. Cl. H04N 7/32

(52) U.S. Cl. 375/240.12; 375/E07.211

(57) ABSTRACT

An image encoding method in an image encoding apparatus is provided. An image encoding apparatus calculates an SATD (Sum of Absolute Transform Difference)-based encoding expense of each of a plurality of intra prediction modes for a current prediction unit. The image encoding apparatus determines at least one or more first candidate encoding modes for the current prediction unit based on the SATD-based encoding expense. The image encoding apparatus determines a final encoding mode among the first candidate encoding modes.

### CROSS-REFERENCE TO RELATED APPLICATION

This application claims priority to Korean Patent Application No. 10-2012-0034691 filed on Apr. 4, 2012, the contents of which are herein incorporated by reference in its entirety.

### TECHNICAL FIELD

The present invention is directed to image encoding, and more specifically to an intra prediction method for enhancing processing speed of an image encoding apparatus.

### DISCUSSION OF THE RELATED ART

As (High Definition) HD-supported broadcast systems are spreading worldwide as well as nationwide, more people become familiar with high-resolution, high quality images, and a number of organizations work hard on developing next-generation imaging apparatuses. Further, more interest is oriented to HDTV and UHD (Ultra High Definition), which supports four-times or more resolution than HDTV, and technologies for compressing even higher-resolution, higher-quality of images are thus demanded.

As technologies used for image compression, there are inter prediction that predicts pixel values included in a current picture from a previous picture and/or a subsequent picture, intra prediction that predicts pixel values using pixel information in a picture, and/or entropy encoding that assigns a relatively shorter code to a symbol that appears more frequently and a relatively longer code to a symbol that appears less frequently.

### SUMMARY

The present invention provides an image encoding method and apparatus.

The present invention provides an intra prediction method that may enhance processing speed of an image encoding apparatus.

The present invention provides a real-time image encoding apparatus.

In an aspect, an image encoding method in an image encoding apparatus is provided. An image encoding apparatus calculates an SATD (Sum of Absolute Transform Difference)-based encoding expense of each of a plurality of intra prediction modes for a current prediction unit. The image encoding apparatus determines at least one or more first candidate encoding modes for the current prediction unit based on the SATD-based encoding expense. The image encoding apparatus determines a final encoding mode among the first candidate encoding modes.

In another aspect, an image encoding apparatus is provided. An image encoding apparatus includes an intra predicting unit that generates a prediction block by performing spatial prediction using a pixel value of an encoded block adjacent to an encoding treeblock, and a subtracter that generates a residual block based on a residual between the encoding treeblock and the prediction block. The intra predicting unit may calculate an SATD (Sum of Absolute Transform Difference)-based encoding expense of each of a plurality of intra prediction modes for a current prediction unit, determine at least one or more first candidate encoding modes for the current prediction unit based on the SATD-based encoding expense, and determine a final encoding mode among the first candidate encoding modes.

### BRIEF DESCRIPTION OF THE DRAWINGS

FIG. 1 is a block diagram illustrating an exemplary structure of an image encoding apparatus.

FIG. 2 is a block diagram illustrating an exemplary structure of an image decoding apparatus.

FIG. 3 is a flowchart illustrating an image encoding method according to an embodiment of the present invention.

FIG. 4 is a conceptual view illustrating a high-speed intra prediction method according to an embodiment of the present invention.

FIG. 5 illustrates a method for determining final encoding mode according to an embodiment of the present invention.

FIG. 6 illustrates 33 prediction directions of intra prediction modes currently supported by an HM.

FIG. 7 illustrates an example of grouping intra prediction modes currently supported by an HM based on prediction directions.

FIG. 8 is a flowchart illustrating a method of determining a transform unit size according to an embodiment of the present invention.

### DESCRIPTION OF THE EMBODIMENTS

Hereinafter, embodiments of the present invention will be described in detail with reference to the accompanying drawings. In describing the embodiments of the present invention, when determined to make the gist of the invention unclear, the detailed descriptions of known configurations or functions will be omitted.

When an element is referred to as being “connected to” or “coupled to” another element, it can be directly connected or coupled to the other element or intervening elements may be present. As used herein, when a specific element is referred to as being “included”, another element may be included within the technical spirit or embodiments of the present invention without being excluded.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present invention. Similarly, the second component may be named as the first component.

The elements in the embodiments are illustrated independently from each other to merely show that the elements perform different functions, and it does not mean that each element cannot be implemented in one hardware or software. That is, each element is discerned for convenience of description. Plural elements may be combined to operate as a single element, or a single element may be divided to operate as plural elements, which is within the scope of the invention as long as it does not depart from the gist of the invention.

Further, some elements may be not necessary elements to perform the fundamental functions but selective elements to enhance capability. The present invention may be implemented as a structure including only the necessary elements except the selective elements, which is also included in the scope of the invention.

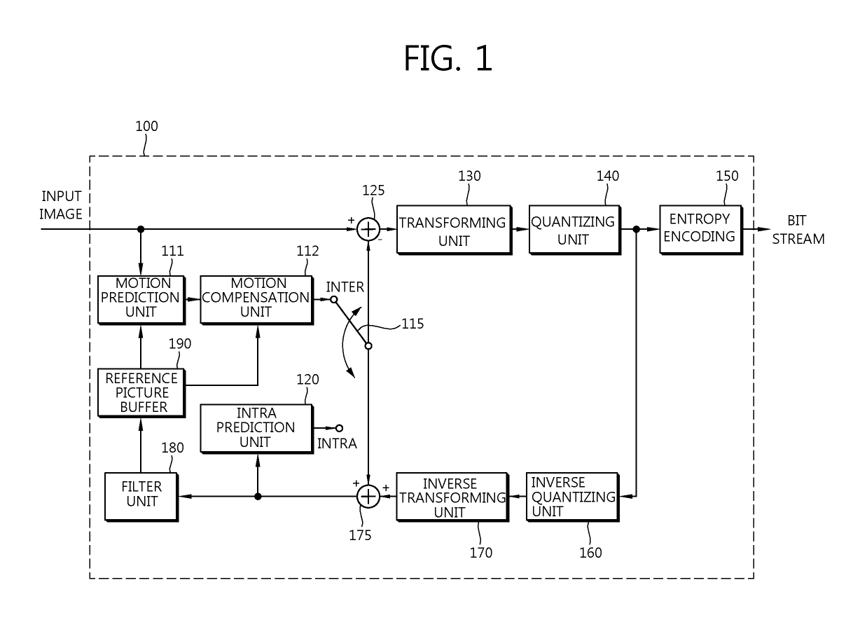

FIG. 1 is a block diagram illustrating an exemplary structure of an image encoding apparatus.

Referring to FIG. 1, the image encoding apparatus 100 includes a motion predicting unit 111, a motion compensation unit 112, an intra predicting unit 120, a switch 115, a subtracter 125, a transforming unit 130, a quantizing unit 140, an entropy encoding unit 150, an inverse quantizing unit 160, an inverse transforming unit 170, an adder 175, a filter unit 180, and a reference picture buffer 190.

The image encoding apparatus 100 encodes an input image in an intra prediction mode or in an inter prediction mode to thereby output a bit stream. Intra prediction means intra frame prediction, and inter prediction means inter frame prediction. The image encoding apparatus 100 switches between the intra prediction mode and the inter prediction mode through a switching operation of the switch 115. The image encoding apparatus 100 generates a prediction block for an input block of the input image and then encodes a residual between the input block and the prediction block.

In the case of the intra prediction mode, the intra predicting unit 120 performs spatial prediction using a pixel value of an already encoded block adjacent to a current block to thereby generate a prediction block.

In the case of the inter prediction mode, the motion predicting unit 111 finds a reference block that matches best with the input block in the reference picture stored in the reference picture buffer 190 during the course of motion prediction and obtains a motion vector. The motion compensation unit 112 generates a prediction block by performing motion compensation using the motion vector. Here, the motion vector is a two-dimensional vector that is used for inter prediction and refers to an offset between a target block of current encoding/decoding and the reference block.

The subtracter 125 generates a residual block based on the residual between the input block and the prediction block, and the transforming unit 130 transforms the residual block and outputs a transform coefficient. The quantizing unit 140 quantizes the transform coefficient to thereby output a quantized coefficient.

The entropy encoding unit 150 performs entropy encoding based on the information obtained during the course of encoding/decoding and outputs a bit stream. The entropy encoding reduces the size of a bit stream for a target symbol of encoding by representing the symbol that occurs frequently with a small number of bits. Accordingly, an enhancement in capability of image compression may be expected through entropy encoding. The entropy encoding unit 150 may use encoding schemes, such as exponential golomb, CAVLC (Context-Adaptive Variable Length Coding), or CABAC (Context-Adaptive Binary Arithmetic Coding) for entropy encoding.

The encoded picture needs to be decoded back and stored so that it can be used as a reference picture for performing intra prediction encoding. Accordingly, the inverse quantizing unit 160 inverse-quantizes the quantized coefficient, and the inverse transforming unit 170 inverse-transforms the inverse-quantized coefficient to thereby output a restored residual block. The adder 175 adds the restored residual block to the prediction block to thereby generate a restored block.

The filter unit 180 is also referred to as an “adaptive in-loop filter”, and applies at least one or more of deblocking filtering, SAO (Sample Adaptive Offset) compensation, and ALF (Adaptive Loop Filtering) to the restored block. The deblocking filtering means removing a block distortion created at a border between blocks, and SAO compensation means adding a proper offset to the pixel value to compensate for a coding error. Further, ALF means performing filtering based on a value obtained by comparing the restored image with the original image.

Meanwhile, the reference picture buffer 190 stores the restored block that has undergone the filter unit 180.

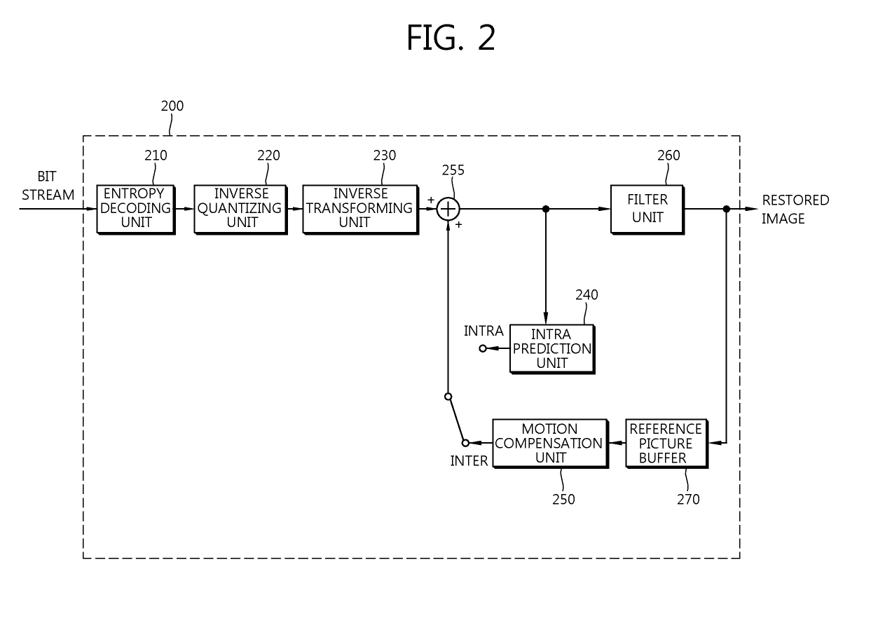

FIG. 2 is a block diagram illustrating an exemplary structure of an image decoding apparatus.

Referring to FIG. 2, the image decoding apparatus 200 includes an entropy decoding unit 210, an inverse quantizing unit 220, an inverse transforming unit 230, an intra predicting unit 240, a motion compensation unit 250, an adder 255, a filter unit 260, and a reference picture buffer 270.

The image decoding apparatus 200 decodes the bit stream in the intra prediction mode or in the inter prediction mode to thereby output a restored image. The image decoding apparatus 200 switches between the intra prediction mode and the inter prediction mode through a switching operation of a switch. The image decoding apparatus 200 obtains a residual block from the bit stream to thereby generate a prediction block and adds the residual block to the prediction block to thereby generate a restored block.

The entropy decoding unit 210 performs entropy decoding based on a probability distribution. The entropy decoding process is an opposite process of the above-described encoding process. That is, the entropy decoding unit 210 generates a symbol including a quantized coefficient from a bit stream obtained by representing a frequently occurring symbol with a smaller number of bits.

The inverse quantizing unit 220 inverse-quantizes the quantized coefficient, and the inverse transforming unit 230 inverse-transforms the inverse-quantized coefficient to thereby generate a residual block.

In the case of the intra prediction mode, the intra predicting unit 240 performs spatial prediction using a pixel value of an already decoded block adjacent to a current block to thereby generate a prediction block.

In the case of the inter prediction mode, the motion compensation unit 250 performs motion compensation using a reference picture stored in the reference picture buffer 270 and the motion vector to thereby generate a prediction block.

The adder 255 adds the residual block to the prediction block, and the filter unit 260 applies at least one or more of deblocking filtering, SAO compensation, and ALF to the block that has undergone the adder to thereby output a restored image.

Meanwhile, the restored image may be stored in the reference picture buffer 270 and used for motion compensation.

Hereinafter, “block” means a unit for encoding/decoding. During the course of encoding/decoding, an image is split to a predetermined size and encoded/decoded. Accordingly, the block may be also referred to as a macro block (MB), a coding unit (CU), a prediction unit (PU), or a transform unit (TU), and one block may be divided into subblocks having a smaller size.

Here, the prediction unit means a basic unit for performing prediction and/or motion compensation. The prediction unit may be split into a plurality of partitions, and each partition is referred to as a prediction unit partition as well. When the prediction unit is split into plural partitions, the prediction unit partition may be a basic unit for performing prediction and/or motion compensation. Hereinafter, in an embodiment of the present invention, the prediction unit may mean the prediction unit partition as well.

Meanwhile, JCT-VC, which is an international video compression standardization organization, is in progress with standardization of a new video compression standard, HEVC (High Efficiency Video Coding). HEVC has introduced various encoding schemes to go beyond encoding capability of a previous video compression standard, H.264/AVC.

The intra prediction, which is an image compression technology, predicts a current coding treeblock using spatial adjacent information only included in current picture without referring to temporarily other pictures. The intra prediction, together with the inter prediction, contributes to enhancement in encoding capability, enables random access, and raises error tolerance of the encoded bit stream. HEVC expands the type of prediction modes to a maximum of 35, thereby providing higher encoding capability than the existing video compression standards.

An encoding method adopted as a standard is integrated with one software for developing an easy encoding tool that allows for fair verification. This software is called ‘HM’ (HEVC test model). The HM includes various algorithms regarding image encoding, such as coding unit (CU), inter prediction, intra prediction, interpolation, filtering, or transform.

An image encoding method using the intra prediction mode effectively predicts a coding treeblock by referring to already decoded spatial adjacent information and encodes only a residual between the predicted block and the coding treeblock. Since in the intra prediction mode the amount of information available for a reference sample is smaller than temporal adjacent information, the intra prediction mode generally has lower encoding capability than the inter prediction mode, but exhibits more excellent capability than the inter prediction mode when the coding treeblock is difficult to be predicted from the temporal adjacent information, such as when a new object appears or illumination varies.

When compared with the intra prediction technologies defined in the previous video compression standards, one of the most critical features of the HEVC intra prediction technology is to support a larger number of prediction modes as shown in Table 1:

TABLE 1

| PU size | Number of intra prediction modes |
|---|---|
| 4 × 4 | 18 |
| 8 × 8 | 35 |
| 16 × 16 | 35 |
| 32 × 32 | 35 |
| 64 × 64 | 4 |

HEVC supports a maximum of 35 intra prediction modes whereas H.264/AVC supports a maximum of 9 intra prediction modes according to the prediction unit size. Accordingly, since intra prediction is conducted using more various prediction modes, accuracy of the prediction may be increased. However, if the number of prediction modes increases, the size of bits assigned to an indicator that indicates which prediction mode has been used for the decoding apparatus increases as well, and thus, increasing the number of the prediction modes does not always guarantee encoding capability. The fact that although a maximum of 35 intra prediction modes are supported, high encoding capability is achieved attests to how well the intra prediction mode in HEVC is designed.

Meanwhile, to select the optimal encoding mode among a number of prediction modes, complexity required for the encoding apparatus has been highly increased. Accordingly, a high-speed intra prediction algorithm is required which may maintain encoding capability while reducing complexity of the encoding apparatus.

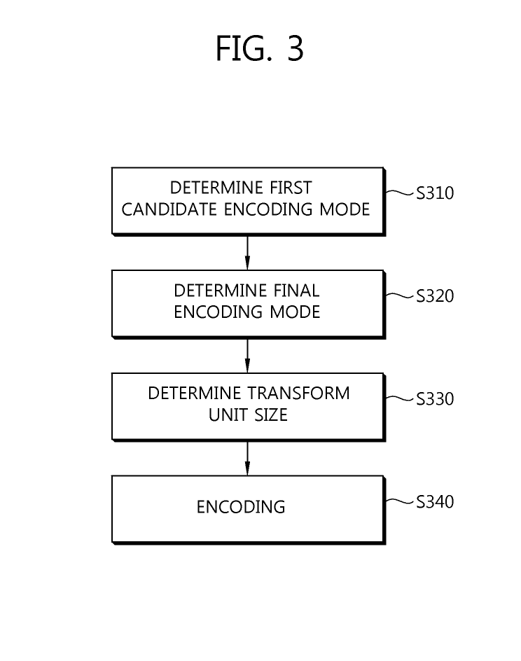

FIG. 3 is a flowchart illustrating an image encoding method according to an embodiment of the present invention.

Referring to FIG. 3, the image encoding method according to an embodiment of the present invention may include a first candidate encoding mode determining step S310, a final encoding mode determining step S320, a transform unit size determining step S330, and an encoding step S340.

To perform a high-speed prediction method according to an embodiment of the present invention, the intra predicting unit in the encoding apparatus calculates an SATD (Sum of Absolute Transform Difference)-based encoding expense of each of plural intra prediction modes of a current prediction unit, and based on the SATD-based encoding expense, determines at least one or more first candidate encoding modes for the current prediction unit (S310). The first candidate encoding mode determining step S310 may be also referred to as a rough mode decision process and may change the number of the first candidate encoding modes determined according to the current prediction unit size.

The SATD-based encoding expense used in the first candidate encoding mode determining step S310 may be determined based on an SATD that is calculated by performing Hadamard transform on residuals between the input sample and the prediction sample and summing the absolute values of the transformed residuals.

After the SATD-based encoding expenses for all the intra prediction modes for the current prediction unit are calculated, N encoding modes whose SATD-based encoding expenses are small are determined as the first candidate encoding modes.

Referring back to FIG. 3, the intra predicting unit determines a final encoding mode among the first candidate encoding modes determined in the first candidate encoding mode determining step S310 (S320). That is, the intra predicting unit calculates the ratio-distortion-based encoding expense only for the encoding modes determined as the first candidate encoding modes and determines the final encoding mode among the first candidate encoding modes.

Finally, the intra predicting unit determines the optimal transform unit size for the current prediction unit (S330) and encodes the coding treeblock based on the transform unit size determined in the transform unit size determining step S330 and the final encoding mode determined in the final encoding mode determining step S320 (S340).

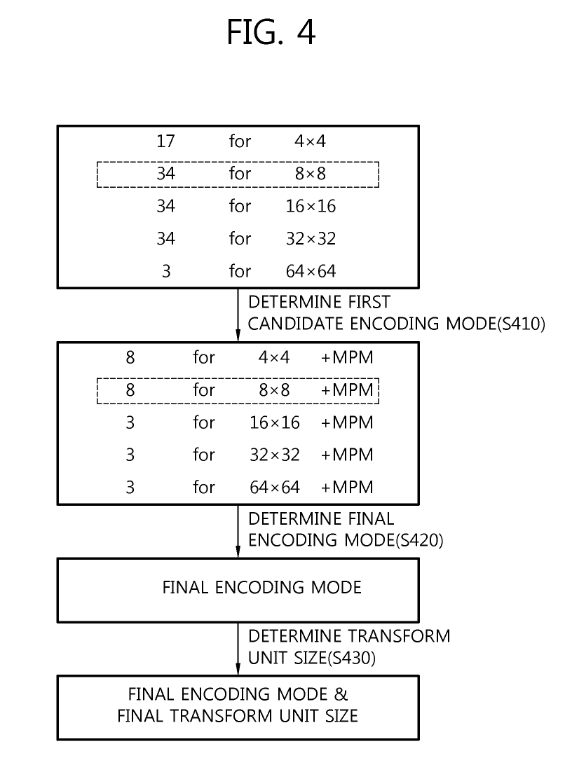

FIG. 4 is a conceptual view illustrating a high-speed intra prediction method according to an embodiment of the present invention.

the first candidate encoding mode determining step S410, the final encoding mode determining step S420, and the transform unit determining step S430 of FIG. 4 corresponds to the first candidate encoding mode determining step S310, the final encoding mode determining step S320, and the transform unit size determining step S330 of FIG. 3.

For example, in the case that the size of the current prediction unit is 8×8, the intra predicting unit calculates the SATD-based encoding expenses for total 34 intra prediction modes and then aligns the intra prediction modes based on the calculated SATD-based encoding expenses, and determines eight intra prediction modes which have the smallest SATD-based encoding expenses among the aligned intra prediction modes as the first candidate encoding modes (S410). At this time, when among the intra prediction modes of the prediction units positioned at the upper or left sides of the current prediction unit, the intra prediction mode having a smaller mode value is not included in the first candidate encoding modes, the corresponding intra prediction mode may be also included in the first candidate encoding modes. The intra prediction mode having a smaller mode value among the intra prediction modes of the prediction units positioned at the upper and left sides of the current prediction unit is called an MPM (Most Probable Mode) and has a correlation very similar to the encoding mode of the current prediction unit. Accordingly, to increase accuracy of the first candidate encoding mode determined for determining the final encoding mode, the intra prediction mode (MPM) having a smaller mode value among the intra prediction modes of the prediction units positioned at the upper and left sides of the current prediction unit may be included in the first candidate encoding modes.

Further, the intra predicting unit determines the final encoding mode among the eight or nine first candidate encoding modes determined in the first candidate encoding mode determining step S410 (S320). At this time, the intra predicting unit may determine the final encoding mode based on the ratio-distortion-based encoding expense of each of the first candidate encoding modes. That is, the encoding mode having the smallest rate-distortion-based encoding expense among the first candidate encoding modes may be determined as the final encoding mode.

Further, the intra predicting unit determines the optimal transform unit size for the current prediction unit (S430). For example, in the case that the size of the current prediction unit is 8×8, the intra predicting unit performs transform on the basis of 8×8 and 4×4 and determines a transform unit having a smaller rate-distortion-based encoding expense as the final transform unit size.

Meanwhile, to enhance encoding capability and perform quicker intra prediction, each step in the above-described image encoding method may be performed as follows.

According to the high-speed intra prediction method currently implemented in the HM, the first candidate encoding mode is determined by simply calculating the SATD of the intra prediction mode. However, when the first candidate encoding mode is determined considering only the SATD, there is the likelihood that the optimal encoding mode is not included in the first candidate encoding modes.

Accordingly, the likelihood that the optimal encoding mode is included in the first candidate encoding modes may be increased by defining as the SATD-based encoding expense a value determined by the following equation:

J_{SATD}=S_{pred}+λB_{pred} [Equation 1]

Here, J_{SATD} refers to the SATD, S_{pred} to the SATD of the intra prediction mode, λ to a predetermined proportional coefficient, and B_{pred} to the bit amount required for the intra prediction mode.

That is, the SATD-based encoding expense is calculated based on the bit amount required for the intra prediction mode together with the SATD of the intra prediction mode. At this time, the bit amount B_{pred} required for the intra prediction mode may be obtained as follows.

In the case that the intra prediction mode is the same as the encoding mode of the prediction unit positioned at the upper or left side of the current prediction unit, that is, when the intra prediction mode is the MPM, the encoding mode of the current prediction unit may be represented by using a flag (1 bit) indicating that the current prediction unit corresponds to the MPM and an indicator (1 bit) indicating which prediction unit the current prediction unit is the same as. Accordingly, in this case, the bit amount of two bits in total is required.

On the contrary, in the case that the intra prediction mode is not the same as the encoding mode of the prediction unit positioned at the upper or left side of the current prediction unit, that is, when the intra prediction mode is not the MPM, the current prediction unit has an encoding mode different from that of the prediction unit positioned at the upper or left side of the current prediction unit, the following bit amount is required to represent the remaining encoding modes.

TABLE 2

| PU size | N |
|---|---|
| 4 × 4 | 4 |
| 8 × 8 | 5 |
| 16 × 16 | 5 |
| 32 × 32 | 5 |
| 64 × 64 | 2 |

Referring to Table 2, in the case that the intra prediction mode is not the MPM, the bit amount required according to the size of the current prediction unit varies.

Meanwhile, the process of calculating the rate-distortion-based encoding expense requires high complexity. In the image encoding method according to an embodiment of the present invention, for reducing the number of candidate encoding modes to calculate the rate-distortion-based encoding expenses, the first candidate encoding mode is determined through the first candidate encoding mode determining steps S310 and S410. However, the process of calculating the rate-distortion-based encoding expense of the first candidate encoding mode still requires high complexity. For instance, in the case that the size of the prediction unit is 8×8, the rate-distortion-based encoding expense needs to be calculated on maximally nine modes.

Accordingly, according to an embodiment of the present invention, to further reduce the number of the candidate encoding modes to calculate the rate-distortion-based encoding expenses, the encoding modes of plural prediction units positioned adjacent to the current prediction unit are referred to.

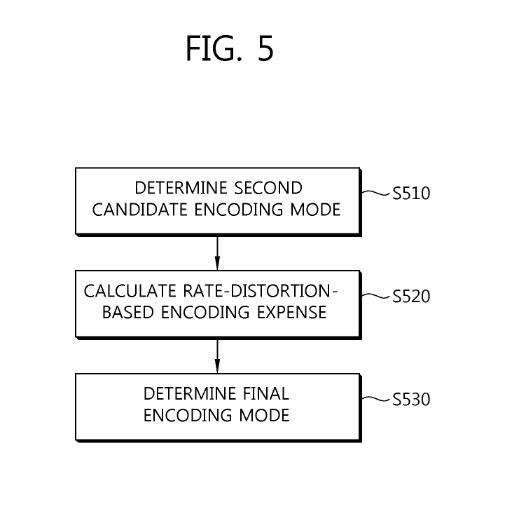

FIG. 5 illustrates a method for determining final encoding mode according to an embodiment of the present invention.

Referring to FIG. 5, the final encoding mode determining steps S320 and S420 respectively shown in FIGS. 3 and 4 may include a second candidate encoding mode determining step S510, a rate-distortion-based encoding expense calculating step S520, and a final encoding mode determining step S530.

The intra predicting unit may determine second candidate encoding modes among the first candidate encoding modes based on the encoding modes of the prediction units positioned adjacent to the current prediction unit (S510). That is, the intra predicting unit lessens once more the encoding modes to calculate the rate-distortion-based encoding expenses based on the encoding modes of the prediction units positioned adjacent to the current prediction unit.

For example, the intra predicting unit may calculate the rate-distortion-based encoding expenses only for the first candidate encoding modes that belong to an encoding mode of the prediction units positioned adjacent to the current prediction unit while discarding the first candidate encoding modes that do not belong to the encoding mode group. Here, the encoding mode group is determined based on the prediction direction of the encoding mode of the prediction unit.

The intra prediction mode performs prediction based on the directivity, and at this time, prediction units positioned spatially adjacent to each other generally have similar directivity. Accordingly, it has a high chance that the prediction direction of the encoding mode of the current prediction unit is similar to the prediction direction of the encoding modes of the prediction units positioned adjacent to the current prediction unit.

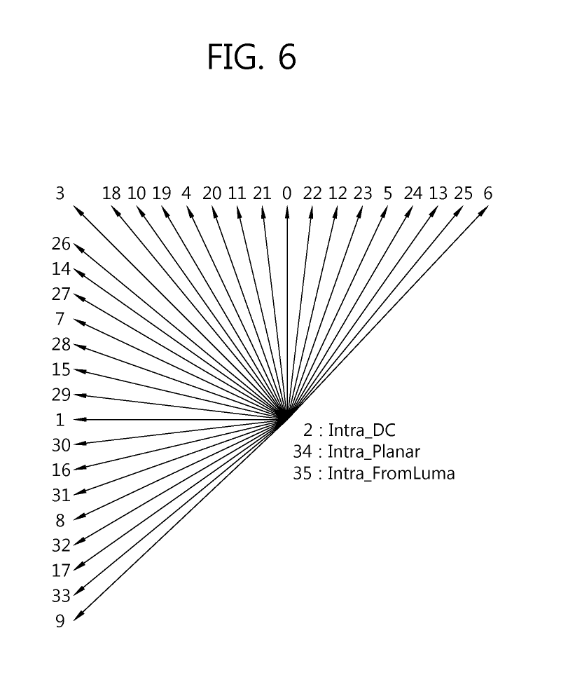

FIG. 6 illustrates 33 prediction directions of the intra prediction modes currently supported by the HM. The prediction directions have been randomly numbered. Accordingly, the numbers may be changed or assigned differently depending on the standard or during the course of standardization

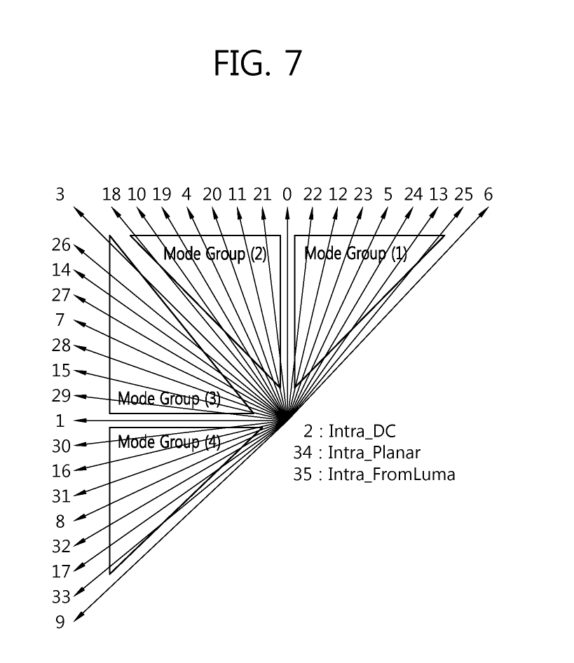

FIG. 7 illustrates an example of grouping the intra prediction modes currently supported by the HM based on the prediction directions.

As another example, in the case that the encoding modes of the prediction units positioned adjacent to the current prediction unit all belong to the same encoding mode group, the intra predicting unit may calculate the rate-distortion-based encoding expenses only for the first candidate encoding modes belonging to the encoding mode group of the prediction units positioned adjacent to the current prediction unit while discarding the first candidate encoding modes not belonging to the encoding mode group. That is, a setting may be done so that the above-described method is performed only when the encoding modes of the prediction units positioned adjacent to the current prediction unit all belong to the same encoding mode group.

Meanwhile, the transform unit size determining steps S330 and S430 respectively shown in FIGS. 3 and 4 require high complexity as well. For example, in the case that the size of the prediction unit is 32×32, the rate-distortion-based encoding expenses are obtained on the transform units which have sizes of 32×32, 16×16, and 8×8, and the optimal transform unit size is then determined.

Accordingly, according to an embodiment of the present invention, it is determined whether the rate-distortion-based encoding expense is to be calculated on the transform unit of a lower level size according to the value of a CBF (Coded Block Flag) for the transform unit having the same size as the prediction unit.

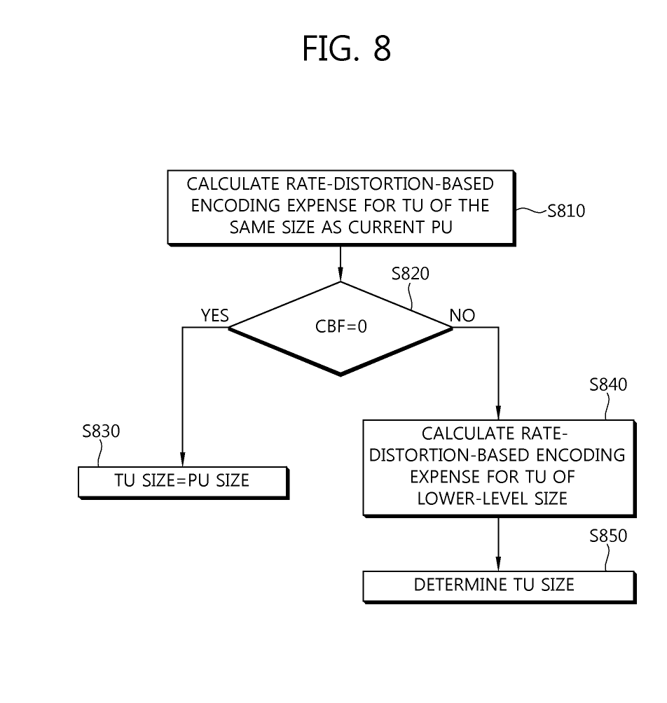

FIG. 8 is a flowchart illustrating a method of determining the transform unit size according to an embodiment of the present invention.

In the final encoding mode determining steps S320 and S420 shown in FIGS. 3 and 4, the intra predicting unit calculates the rate-distortion-based encoding expense, and based on the rate-distortion-based encoding expense, determines the final encoding mode. At this time, the rate-distortion-based encoding expense for the transform unit that has the same size as the current prediction unit is generally calculated.

If after transform is done to the same size as the current prediction unit, the transform unit having the same size as the current prediction unit has a CBF (Coded Block Flag) value of 0, this means that the residual signals after the quantizing step are all 0's, the final transform unit size may be determined as having the same size as the current prediction unit without calculating the rate-distortion-based encoding expense for the transform unit of a lower level size.

Referring to FIG. 8, the transform unit size determining steps S330 and S430 shown in FIGS. 3 and 4 according to an embodiment of the present invention include a step S820 of determining whether to calculate the rate-distortion-based encoding expense, a step S840 of calculating the rate-distortion-based encoding expense for the lower-level size transform unit, and transform unit size determining steps S830 and S850.

As described above, when the rate-distortion-based encoding expense for the transform unit having the same size as the current prediction unit is calculated in the final encoding mode determining steps S320 and S420 of FIGS. 3 and 4 (S810), the intra predicting unit verifies the CBF for the transform unit of the same size as the current prediction unit to thereby determine whether to calculate the rate-distortion-based encoding expense for the lower-level size transform unit as well (S820).

In the case that the CBFs are all 0's for brightness/chrominance components, this means that all the residual signals, after the quantizing step, are 0's, and thus, the final transform unit size is determined as being the same as the size of the current prediction unit without performing calculation of the rate-distortion-based encoding expense for the lower-level size transform unit (S830).

On the contrary, when the CBFs are not 0, the intra prediction unit calculates the rate-distortion-based encoding expense for the lower-level size transform unit as well (S840) and determines the size of the transform unit having the smallest rate-distortion-based encoding expense as the final transform unit size (S850).

Although the above embodiments are described through the flowcharts having a series of steps or blocks, the present invention is not limited to the above-described steps or the order of the steps, while some steps may be performed in a different order from other steps or concurrently with other steps. It will be understood by those skilled in the art that the steps of each flowchart do not exclude each other, with other steps included or some steps excluded.

The above-described embodiments include various aspects of examples. To represent various aspects, all possible combinations thereof may not be described, but it will be apparent by those skilled in the art that such other combinations are possible, too. Accordingly, all other changes, modifications, and alternations to the embodiments may be made within the scope of the appended claims.

1. An image encoding method in an image encoding apparatus, the image encoding method comprising:
calculating an SATD (Sum of Absolute Transform Difference)-based encoding expense of each of a plurality of intra prediction modes for a current prediction unit;
determining at least one or more first candidate encoding modes for the current prediction unit based on the SATD-based encoding expense; and
determining a final encoding mode among the first candidate encoding modes.

2. The image encoding method of claim 1, wherein the SATD-based encoding expense is determined based on an SATD of each of the plurality of intra prediction modes and a bit amount required by each of the plurality of intra prediction modes.

3. The image encoding method of claim 2, wherein the SATD-based encoding expense is determined by the following equation:
J_{SATD}=S_{pred}+λB_{pred}
wherein J_{SATD} is the SATD-based encoding expense, S_{pred} is the SATD of each of the plurality of intra prediction modes, λ is a predetermined proportional coefficient, and B_{pred} is the bit amount required by each of the plurality of intra prediction modes.

4. The image encoding method of claim 3, wherein each of the plurality of intra prediction modes is the same as an encoding mode of a prediction unit positioned at an upper or left side of the current prediction unit, and wherein the bit amount is 2.

5. The image encoding method of claim 3, wherein each of the plurality of intra prediction modes is different from an encoding mode of a prediction unit positioned at an upper and left side of the current prediction unit, and wherein the bit amount is determined based on a size of the current prediction unit.

6. The image encoding method of claim 1, wherein the final encoding mode is determined based on the rate-distortion-based encoding expense of each of the first candidate encoding modes.

7. The image encoding method of claim 1, further comprising determining a transform unit size for the current prediction unit, wherein the final encoding mode is determined based on the rate-distortion-based encoding expense of each of the first candidate encoding modes for a transform unit having the same size as the current prediction unit, and wherein determining the transform unit size includes determining whether to calculate the rate-distortion-based encoding expense of each of the first candidate encoding modes for a transform unit having a smaller size than the current prediction unit based on a CBF (Coded Block Flag) for a transform unit having the same size as the current prediction unit.

8. The image encoding method of claim 7, wherein the CBF is 0, and wherein the transform unit size is determined as being the same as the size of the current prediction unit.

9. The image encoding method of claim 1, wherein determining the final candidate encoding mode includes, determining at least one or more second candidate encoding modes among the first candidate encoding modes based on a encoding modes of a plurality of prediction units positioned adjacent to the current prediction unit; and calculating a rate-distortion-based encoding expense of each of the second candidate encoding modes to thereby determine a final encoding mode.

10. The image encoding method of claim 1, further comprising determining a transform unit size for the current prediction unit, wherein determining the final candidate encoding mode includes, determining at least one or more second candidate encoding modes among the first candidate encoding modes based on a encoding modes of a plurality of prediction units positioned adjacent to the current prediction unit; and calculating a rate-distortion-based encoding expense of each of the second candidate encoding modes for a transform unit having the same size as the current prediction unit to thereby determine a final encoding mode, wherein determining the transform unit size includes determining whether to calculate a rate-distortion-based encoding expense of each of the second candidate encoding modes for a transform unit having a smaller size than the current prediction unit based on a CBF (Coded Block Flag) for a transform unit having the same size as the current prediction unit.

11. The image encoding method of claim 10, wherein the CBF is 0, and wherein the transform unit size is determined as being the same size as the current prediction unit.

12. An image encoding apparatus comprising: an intra predicting unit that generates a prediction block by performing spatial prediction using a pixel value of an encoded block adjacent to an encoding treeblock; and a subtracter that generates a residual block based on a residual between the encoding treeblock and the prediction block, wherein the intra predicting unit calculates an SATD (Sum of Absolute Transform Difference)-based encoding expense of each of a plurality of intra prediction modes for a current prediction unit, determines at least one or more first candidate encoding modes for the current prediction unit based on the SATD-based encoding expense, and determines a final encoding mode among the first candidate encoding modes.

13. The image encoding apparatus of claim 12, wherein the SATD-based encoding expense is determined based on an SATD of each of the plurality of intra prediction modes and a bit amount required by each of the plurality of intra prediction modes.

14. The image encoding apparatus of claim 12, wherein the intra predicting unit determines at least one or more second candidate encoding modes among the first candidate encoding modes based on a encoding modes of a plurality of prediction units positioned adjacent to the current prediction unit and calculates a rate-distortion-based encoding expense of each of the second candidate encoding modes to thereby determine a final encoding mode.
